(19) United States
(12) Patent Application Publication
(10) Pub. No.: US 2016/0198675 A1
(43) Pub. Date: Jul. 14, 2016

(54) PET BEDDING

(71) Applicant: YAO I FABRIC CO., LTD., Chang-Hwa County (TW)

(72) Inventor: YEN TING LIU, CHANG-HWA COUNTY (TW)

(21) Appl. No.: 14/623,711

(22) Filed: Feb. 17, 2015

(30) Foreign Application Priority Data
Jan. 8, 2015 (TW) 104200309

(51) Int. Cl. A01K 1/035

(52) U.S. Cl. CPC A01K 1/0353

(57) ABSTRACT

A pet bedding contains: a body and a connecting assembly. The body includes a plurality of pads which are in connection together, and the body includes an accommodating room formed therein, a neck portion with a diameter smaller than the accommodating room, and an opening defined in the neck portion and communicating with the accommodating room. The connecting assembly includes a main connection strap and a plurality of auxiliary connection straps, wherein the main connection strap is horizontally wrapped around an upper end of an outer wall of the body adjacent to the neck portion and is longitudinally wrapped around two opposite sides of the outer wall of the body, and a flat pressed area is formed on two of the plurality pads of the body which are formed on an upper surface and a lower surface of the outer wall of the body.

### FIELD OF THE INVENTION

The present invention relates to a pet bedding which is also used for a pet nest.

### BACKGROUND OF THE INVENTION

A conventional pet nest can be expanded like a bed, a tent or a house. The pet nest contains an accommodating room made of fabrics and contains an opening formed on an outer wall of the pet nest, such that a pet enters into and stays at the pet nest.

The present invention has arisen to mitigate and/or obviate the afore-described disadvantages.

### SUMMARY OF THE INVENTION

The primary objective of the present invention is to provide a pet bedding which is also used for a pet nest.

To obtain the above objective, a pet bedding contains: a body and a connecting assembly.

The body includes a plurality of pads which are in connection together, and the body includes an accommodating room formed therein, a neck portion with a diameter smaller than the accommodating room, and an opening defined in the neck portion and communicating with the accommodating room.

The connecting assembly includes a main connection strap and a plurality of auxiliary connection straps, wherein the main connection strap is horizontally wrapped around an upper end of an outer wall of the body adjacent to the neck portion and is longitudinally wrapped around two opposite sides of the outer wall of the body, and a flat pressed area is formed on two of the plurality pads of the body which are formed on an upper surface and a lower surface of the outer wall of the body.

As desiring to expand the body like a pet nest, the body is expanded outwardly to form the accommodating room, after inserting user's hand into the opening to expand the six pads of the body outwardly, such that the pet enters into and stays at the accommodating room from the opening.

The body is folded and pressed flatly along the main connection strap by forcing the neck portion to press the opening flatly, such that the pat bedding with the flat pressed area is formed so that the pet, such as a cat, lies on the flat pressed area.

### BRIEF DESCRIPTION OF THE DRAWINGS

FIG. 1 is a perspective view showing the assembly of a pet bedding according to a preferred embodiment of the present invention.

FIG. 2 is another perspective view showing the assembly of the pet bedding according to the preferred embodiment of the present invention.

FIG. 3 is also another perspective view showing the assembly of the pet bedding according to the preferred embodiment of the present invention.

FIG. 4 is a perspective view showing the operation of the pet bedding according to the preferred embodiment of the present invention.

FIG. 5 is another perspective view showing the operation of the pet bedding according to the preferred embodiment of the present invention.

FIG. 6 is a perspective view showing the application of the pet bedding according to the preferred embodiment of the present invention.

FIG. 7 is another perspective view showing the application of the pet bedding according to the preferred embodiment of the present invention.

### DETAILED DESCRIPTION OF THE PREFERRED EMBODIMENTS

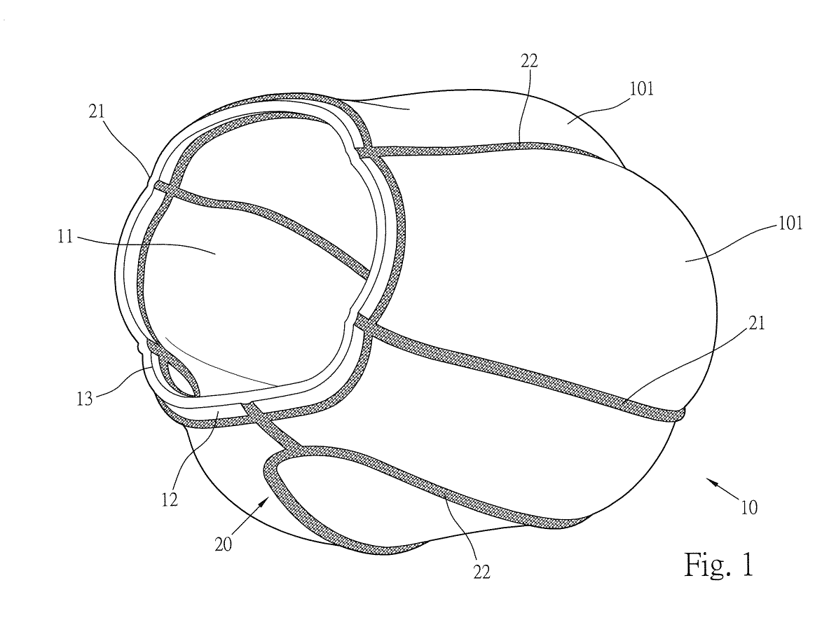

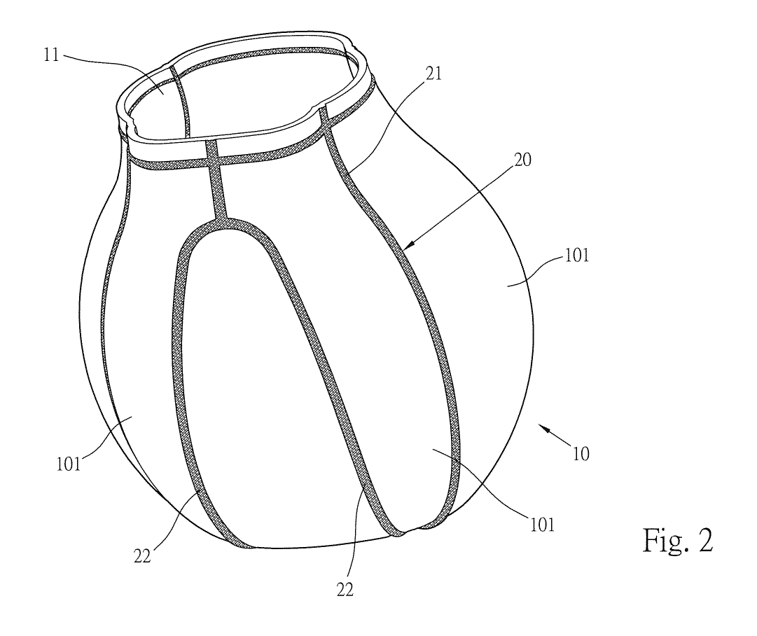

With reference to FIGS. 1 and 2, a pet bedding according to a first embodiment of the present invention comprises: a body 10 and a connecting assembly 20.

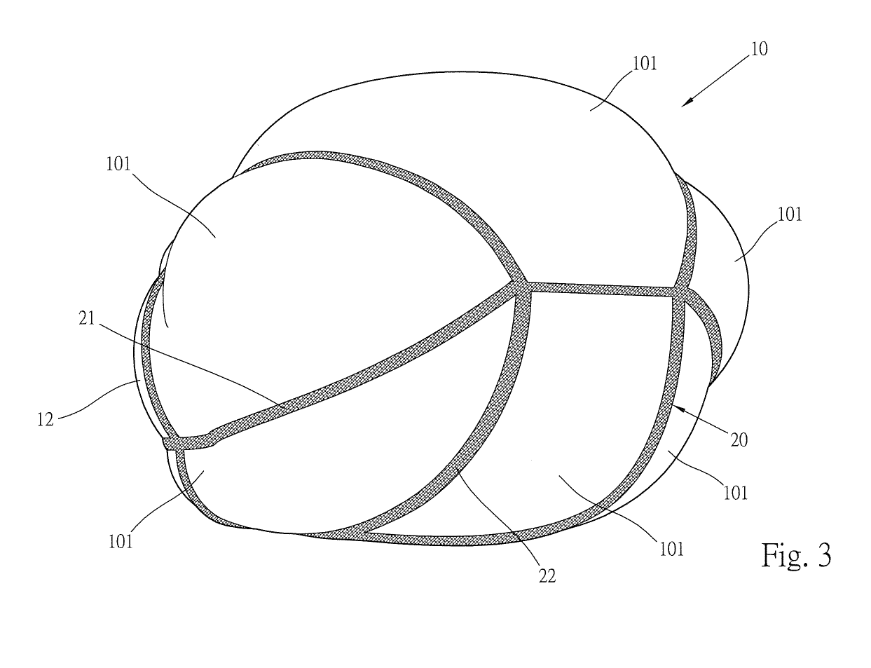

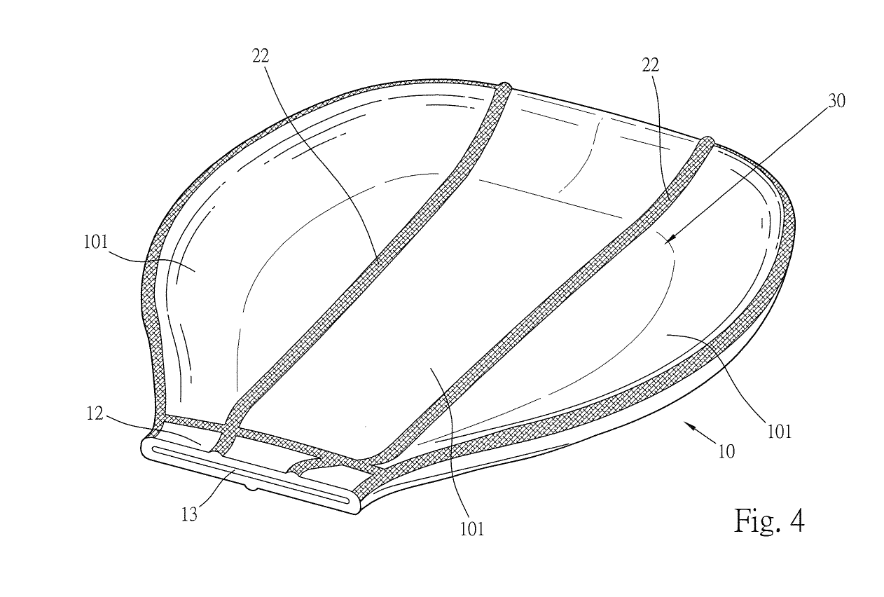

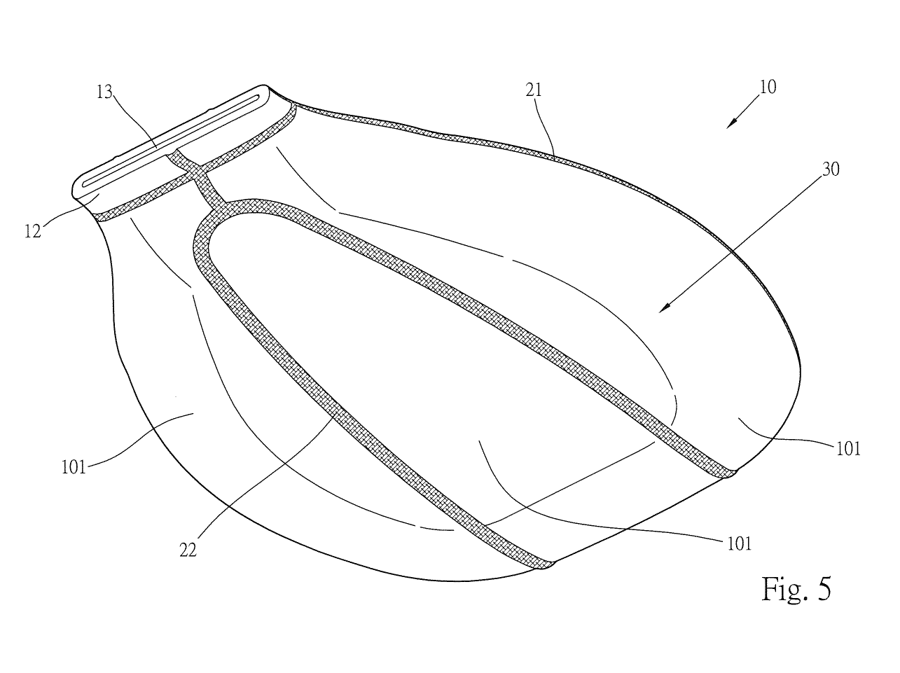

The body 10 includes six pads 101 which are made of non-woven fabrics and are in connection together in a sewing manner or a hot melting manner (such as a hot melt high frequency), such that the body 10 is formed in a hollowly circular drum, as shown in FIGS. 1 to 3, the body 10 includes an accommodating room 11 formed therein, a neck portion 12 with a diameter smaller than the accommodating room 11, and an opening 13 defined in the neck portion 12 and communicating with the accommodating room 11. The connecting assembly 20 includes a main connection strap 21 and a plurality of auxiliary connection straps 22, wherein the main connection strap 21 is horizontally wrapped around an upper end of an outer wall of the body 10 adjacent to the neck portion 12 and is longitudinally wrapped around two opposite sides of the outer wall of the body 10, such that the body 10 is folded and pressed flatly along the main connection strap 21 which is longitudinally wrapped around the two opposite sides of the outer wall of the body 10, thus forming the pet bedding as illustrated in FIGS. 4 and 5. Preferably, a flat pressed area 30 is formed on two of the six pads 101 of the body 10 which are formed on an upper surface and a lower surface of the outer wall of the body 10, hence a pet lies on the two pads 101.

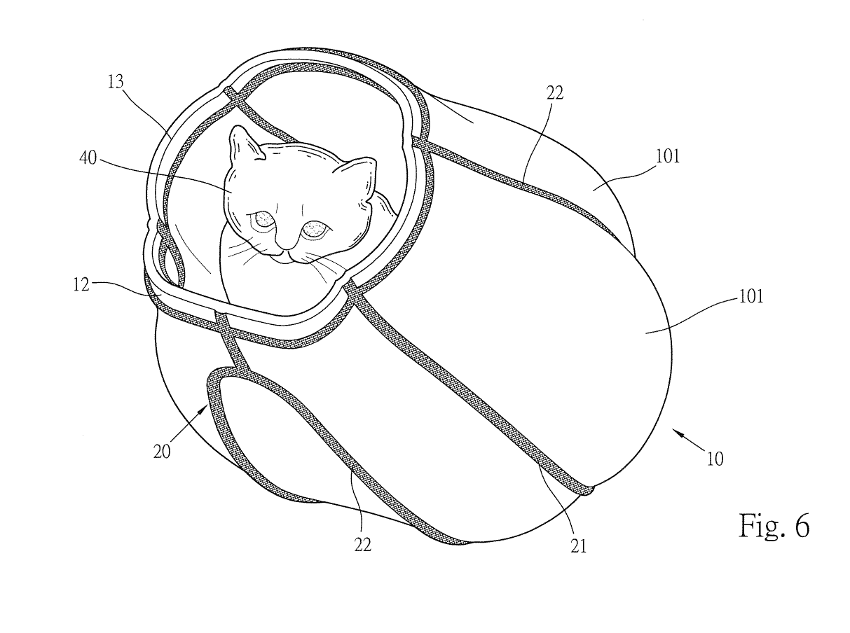

Referring to FIGS. 1 and 2, as desiring to expand the body 10 like a pet nest, the body 10 is expanded outwardly to form the accommodating room 11, after inserting user's hand into the opening 13 to expand the six pads 101 of the body 10 outwardly, such that the pet 40 enters into and stays at the accommodating room 11 from the opening 13, as illustrated in FIG. 6.

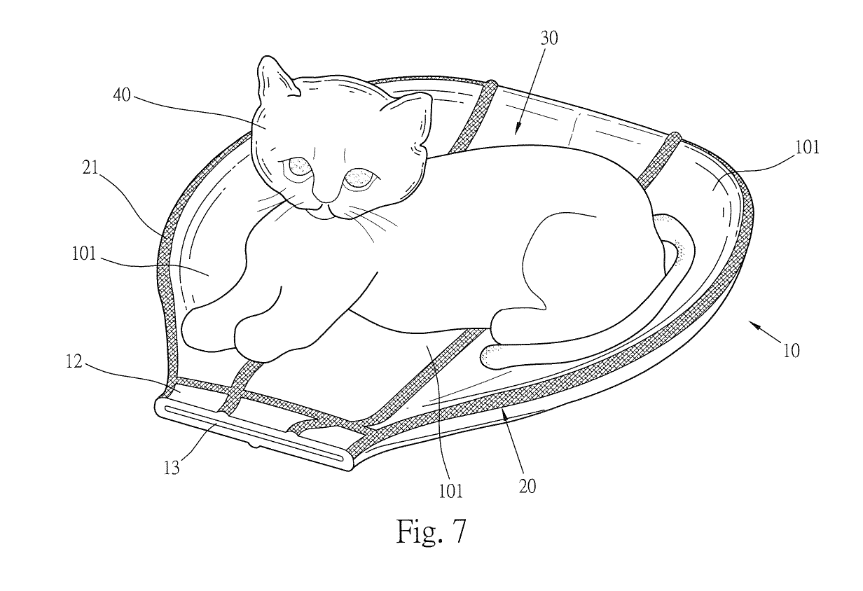

With reference to FIGS. 4 and 5, the body 10 is folded and pressed flatly along the main connection strap 21 by forcing the neck portion 12 to press the opening 13 flatly, such that the pat bedding with the flat pressed area 30 is formed so that the pet 40, such as a cat, lies on the flat pressed area 30 as shown in FIG. 7.

Thereby, the pet bedding of the present invention is also used for the pet nest.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A pet bedding comprising: a body and a connecting assembly, wherein
the body includes a plurality of pads which are in connection together, and the body includes an accommodating room formed therein, a neck portion, and an opening defined in the neck portion and communicating with the accommodating room;
the connecting assembly includes a main connection strap and a plurality of auxiliary connection straps, wherein the main connection strap is horizontally wrapped around an upper end of an outer wall of the body adjacent to the neck portion and is longitudinally wrapped around two opposite sides of the outer wall of the body, and a flat pressed area is formed on two of the plurality pads of the body which are formed on an upper surface and a lower surface of the outer wall of the body.

2. The pet bedding as claimed in claim 1, wherein the plurality of pads which are made of non-woven fabrics, and a number of the plurality of pads is six.

3. The pet bedding as claimed in claim 1, wherein the neck portion has a diameter smaller than the accommodating room.
